(19) United States
(12) Patent Application Publication
(10) Pub. No.: US 2024/0227718 A9
(43) Pub. Date: Jul. 11, 2024

(54) JOINT CONNECTION COMPRISING A GLASS, GLASS, IN PARTICULAR FOR PRODUCING A JOINT CONNECTION, AND FEEDTHROUGH COMPRISING A GLASS AND/OR A JOINT CONNECTION, AND METHOD FOR PRODUCING SAME

(71) Applicant: Schott AG, Mainz (DE)

(72) Inventors: Ina Mitra, Stadecken-Elsheim (DE); Christian Mix, Landshut (DE); Reinhard Ranftl, Pfeffenhausen (DE); Ondrej Rousek, Zamberk (CZ)

(73) Assignee: Schott AG, Mainz (DE)

(21) Appl. No.: 18/400,110

(22) Filed: Dec. 29, 2023

Related U.S. Application Data
(63) Continuation of application No. PCT/EP2022/067865, filed on Jun. 29, 2022.

(30) Foreign Application Priority Data
Jun. 30, 2021 (DE) 10 2021 116 806.6
Jun. 29, 2022 (WO) PCT/EP2022/067865

(51) Int. Cl. B60R 21/26; C03C 8/24; H01R 9/16

(52) U.S. Cl. CPC B60R 21/26; C03C 8/24; H01R 9/16; B60R 2021/26029; H01R 2201/26

(57) ABSTRACT

A joining connection for an airbag igniter includes an electrically insulating component including a glass and at least two joining partners, the at least two joining partners being kept electrically insulated from one another by the electrically insulating component.

### CROSS REFERENCE TO RELATED APPLICATIONS

This is a continuation of International Patent Application No. PCT/EP2022/067865 filed on Jun. 29, 2022, which is incorporated in its entirety herein by reference. International Patent Application No. PCT/EP2022/067865 claims priority to German Patent Application No. 10 2021 116 806.6 filed on Jun. 30, 2021, which is incorporated in its entirety herein by reference.

### BACKGROUND OF THE INVENTION

### 1. Field of the Invention

The invention relates generally to a joining connection comprising a glass and a joining partner, especially a joining connection comprising a glass that may also be configured so as to be at least partly crystallizing or at least partly crystallized. Further aspects relate to a glass, especially a glass for production of a joining connection, especially comprising at least one joining partner, and to a feedthrough (or a feedthrough element) comprising such a glass and/or such a joining connection. Yet a further aspect of the present disclosure relates to a method of producing such a joining connection and/or such a feedthrough.

### 2. Description of the Related Art

What are called feedthroughs (which can also be referred to as feedthrough elements) are used in particular applications, for example in the field of sensors, as in particle sensors, exhaust gas sensors, pressure sensors, or for bushings, or else, for example, in an igniter, for example an airbag igniter. Feedthroughs generally comprise a joining connection comprising an electrically insulating component and at least two joining partners. At least the at least two joining partners are kept electrically insulated from one another by the electrically insulating component.

The insulating component may generally comprise an insulator, especially a glass, or else consist of an insulator, for example a glass. Glasses are especially advantageous because they, in the process of producing such a joining connection and/or a feedthrough, the glass at least partly melts and fuses to the joining partner(s), i.e. a bond, especially a cohesive bond, is formed between the glass and the joining partner and is able to establish a corresponding good connection thereto. Thus, specifically glasses are of very good suitability as constituents of an electrically insulating component in such joining connections and/or in corresponding feedthroughs, since they are not just electrically insulating but also suitable for the production of very tight, optionally hermetically sealed, joining connections.

Some joining connections for use in feedthroughs are used in the mechanically particularly demanding sectors, for example including in the airbag igniters mentioned at the outset. For this purpose, high-strength joining connections are required, or corresponding high-strength feedthroughs. But the provision of such high-strength feedthroughs or joining connections is contrary to a trend toward increasing miniaturization of components, the effect of which is that, because of the decrease in size of the component and hence, for example, of the contact area between the glass and the joining partner(s), there is also a corresponding reduction in the mechanical strength of the connection or of the feedthrough comprising said connection.

In order to obtain high-strength joining connections and correspondingly a high-strength feedthrough even in the case of relatively small feedthroughs that can be used in an airbag igniter, for example, a known method is in particular to use at least partly crystallizing or at least partly crystallized glasses as constituents of an electrically insulating component. This is because, in the case of such at least partly crystallizable and/or at least partly crystallized glasses, it is possible for a crystallite microstructure or crystal microstructure to form, in which the crystallites or crystals are interdigitated, for example, in the at least partly crystallized glass and hence can advantageously promote or increase the strength of the electrically insulating component.

However, a disadvantage of this can be that, in the production of the electrically insulating component, particular attention has to be paid specifically to this property of the crystallization that takes place at least to some degree, such that the crystallization does indeed take place in a controlled manner. This is because the crystallization also alters, especially increases, the melting temperature and the melting characteristics of the at least partly crystallizing or crystallized glass, so that it is barely still possible, if at all, for there to be any flow onto the joining partner(s) and correspondingly the formation of a firm connection, for example a cohesive bond, between the at least partly crystallizing or crystallized glass and the joining partner(s), or this is possible only with application of an additional external pressure.

U.S. Pat. No. 7,989,373 B2 describes materials for hermetic sealing of surfaces, for example of surfaces of a porous ceramic substrate. There is no description of a joining connection, especially not of a joining connection that would be usable for airbag igniters.

European patent application EP 0 982 274 A2 describes glass solders that can be used in fuel cells, for example. There is no description, however, of joining connections as used, for example, for airbag igniters or in feedthroughs for airbag igniters. In particular, the glasses provided according to EP 982 274 A2 show insufficient glass pushout forces and distinct bubble formation.

International patent application WO 2014/107631 A1 relates to glasses having a high content of divalent metal oxides of more than 40 mol % that are used in fuel cells. There is no description of joining connections suitable for airbag igniters.

European patent application EP 3 450 410 A1 describes a tubular glass product for sealing against a metal. The glasses have a relatively low content of alkaline earth metal oxides and a comparatively high content of glass formers. There is no description of joining connections having high strength.

US patent application US 2019/0023605 A1 describes a sealing glass for a feedthrough in a refrigerator or a cooling system, wherein the glass does not have excessive shrinkage at the glass transition temperature or within a temperature range around the glass transition temperature, in order to avoid cracking. There is no description of joining connections having very high strength, especially not of joining connections that use a high glass pushout force and/or airbag igniters or in feedthroughs for airbag igniters.

US patent application US 2005/0277541 A1 describes a glass frit of a sealing glass, especially suitable for fuel cells.

US patent application US 2006/0019813 A1 relates to sealing glasses for fuel cells.

US patent application US 2006/0172875 A1 describes a sealing glass having a low alkali content that can be used for fuel cells in particular. There is no mention of joining connections for airbag igniters, for example, or suitable for these.

US patent application US 2009/0325349 A1 describes a material for encapsulating semiconductors for applications in the region of 500° C.

European patent application EP 1 083 155 A1 describes a ceramic glass frit for glazes.

None of the aforementioned prior art documents describes high-strength joining connections for airbag igniters or suitable for airbag igniters, for example for use in feedthroughs for such igniters.

There is therefore generally a need for a joining connection that has high mechanical strength, especially with regard to a force needed to push out the insulating component, and that at least partly attenuates the shortcomings of the prior art, and for feedthroughs comprising such a joining connection. In addition, there is also a need for a production process for such a joining connection and/or for such a feedthrough.

### SUMMARY OF THE INVENTION

In some embodiments provided according to the invention, a joining connection for an airbag igniter includes an electrically insulating component including a glass and at least two joining partners, the at least two joining partners being kept electrically insulated from one another by the electrically insulating component.

In some embodiments provided according to the invention, a glass includes: at least one glass-forming metal oxide or semimetal oxide of the general formula RO₂ or R₂O₃, where a sum total of all metal oxides or semimetal oxides of the general formula RO₂ or R₂O₃ that are encompassed by the glass is at least 50 mol % to at most 70 mol %, the at least one glass-forming metal oxide or semimetal oxide comprising SiO₂, Al₂O₃, B₂O₃, ZrO₂, La₂O₃, P₂O₅, Fe₂O₃ TiO₂, and/or mixtures thereof; and at least one metal oxide of the general formula MO, the at least one metal oxide of the general formula MO comprising an alkaline earth metal or ZnO. A molar ratio of a sum total of the at least one metal oxide of the general formula MO encompassed by the glass to a sum total of the at least one glass-forming metal oxide or semimetal oxide of the general formula RO₂ or R₂O₃ encompassed by the glass is between at least 0.29 and at most 0.59.

In some embodiments provided according to the invention, a method of producing a joining connection includes: melting a glass, the glass comprising: at least one glass-forming metal oxide or semimetal oxide of the general formula RO₂ or R₂O₃, where a sum total of all metal oxides or semimetal oxides of the general formula RO₂ or R₂O₃ that are encompassed by the glass is at least 50 mol % to at most 70 mol %, the at least one glass-forming metal oxide or semimetal oxide comprising SiO₂, Al₂O₃, B₂O₃, ZrO₂, La₂O₃, P₂O₅, Fe₂O₃TiO₂, and/or mixtures thereof; and at least one metal oxide of the general formula MO, the at least one metal oxide of the general formula MO comprising an alkaline earth metal or ZnO, a molar ratio of a sum total of the at least one metal oxide of the general formula MO encompassed by the glass to a sum total of the at least one glass-forming metal oxide or semimetal oxide of the general formula RO₂ or R₂O₃ encompassed by the glass is between at least 0.29 and at most 0.59; producing a preform, producing the preform comprising producing ribbons and/or fits from the glass or comprising the glass, the ribbons and/or fits are ground to powder and processed to give compressible granules that are compressed to produce the preform, or hot forming to obtain a tube comprising the glass or composed of the glass as the preform; assembling the preform with at least one joining partner; and transferring the preform and the at least one joining partner to a kiln to perform a thermal treatment, such that the glass adapts and a connection is formed between the glass and the at least one joining partner.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawing(s), wherein:

FIG. 1A shows, in 2000× magnification, the microstructure image of a preform obtained via the sintering route in the corresponding joining connection;

FIG. 1B shows, in 1000× magnification, the microstructure of a preform obtained by pipe drawing in the corresponding joining connection; and

FIG. 2 shows, in a schematic diagram which is not true to scale, a joining connection provided according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The present disclosure relates to a joining connection, especially joining connection for an airbag igniter or usable in a feedthrough for an airbag igniter, comprising an electrically insulating component and at least two joining partners, wherein at least the two joining partners are kept electrically insulated from one another by the electrically insulating component. The insulating component comprises or consists of a glass, optionally a glass comprising not more than 2% to 3% by volume of crystals and/or crystallites, optionally an essentially crystallite-free glass. The joining connection optionally has a maximum glass pushout force, optionally determined for a vitrification length of 3 mm or up to 3 mm, but of at least 0.5 mm, of more than 3900 N, optionally of at least 4000 N. The glass pushout force is optionally determined as the average glass pushout force for a totality of 12 to 25 joining connections. In particular, the glass pushout force can optionally be determined in a method of determining the pushout force as described hereinafter.

It has been found that, surprisingly, the glass pushout force is dependent only to a minor degree on the exact vitrification length, especially in the vitrification length range from 0.5 mm to 5 mm or in particular from 2 to 3 mm.

It is also possible to quote a glass pushout force per mm of vitrification length. The glass pushout force is optionally more than 1300 N per mm of vitrification length, in particular at least 1330 N per mm of vitrification length, optionally at least within a range of vitrification lengths from 0.5 mm to 5 mm or from 2 to 3 mm.

For this purpose, a joining connection is mounted by a clamp device in a receptacle or holder, where the clamp device has a lower part and an upper part. A test needle disposed on the upper part of the clamp device presses against the joining connection. By linearly increasing the force with which the test needle presses against the joining connection, it is possible to ascertain the force at which the joining connection gives way.

In general, the glass optionally comprises:
at least one glass-forming metal oxide or semimetal oxide, GB, of the general formula RO₂ or R₂O₃,
at least one metal oxide of the general formula MO, where a glass-forming metal oxide and/or semimetal oxide, GB, is especially understood to mean SiO₂, Al₂O₃, B₂O₃, ZrO₂, La₂O₃, P₂O₅, Fe₂O₃ and/or TiO₂ and/or mixtures thereof,
where a metal oxide of the general formula MO is especially understood to mean an alkaline earth metal or ZnO,
and where the molar ratio of the sum total of the metal oxides, MO, that are encompassed by the glass to the sum total of glass formers, GB, that are encompassed by the glass is between at least 0.29 and at most 0.59.

Thus, in general:

0.29≤ΣMO/ΣGB≤0.59.

In general, the molar ratio ΣMO/ΣGB in some embodiments may be at least 0.29, optionally at least 0.30, optionally at least 0.31. In some embodiments, the molar ratio ΣMO/ΣGB is at most 0.58, optionally at most 0.55.

The vitrification length is generally understood to mean the shortest length of the interface between the electrically insulating component and a joining partner of the joining connection in axial direction. Because of meniscus formation, it is possible here that the vitrification length may be different in the case of the two joining partners. Optionally, in the region of the vitrification length, the fusing forms an optionally coherent bond between the glass which is encompassed by the electrically insulating component, or of which the electrically insulating component consists, and at least one joining partner, optionally both joining partners.

Such a joining connection may be very advantageous. This is because it has been found that, surprisingly, such a glass that has the above-specified molar ratio of the sum total of the metal oxides MO that are encompassed by the glass to the sum total of the glass formers GB that are encompassed by the glass, namely between at least 0.29 and at most 0.59, can firstly be used to obtain a very high strength in a resulting joining connection, especially also for comparatively short vitrification lengths of, for example, only 3 mm or 2 mm. It is thus possible, for example, to obtain feedthroughs that can be used in airbag igniters. In particular, this enables glass pushout forces as specified above.

But it is also a particular advantage that such high-strength joining connections and/or feedthroughs can specifically also be obtained for a glass that specifically comprises optionally not more than 2-3% by volume of crystallites and/or crystals, where the glass is optionally even in essentially crystallite-free form, i.e. comprises not more than 1% by volume of crystallites and/or crystals or is even in entirely crystallite-free form. In other words, this means that the total content of crystals and/or crystallites in the glass is optionally not more than 2% to 3% by volume or may even be in crystallite-free or crystal-free form, i.e. comprises a total of not more than 1% by volume of crystals and/or crystallites. Crystallites are generally understood to mean small crystals having a diameter of not more than 1 μm. It is generally possible that a glass comprises solely crystals, or else solely crystallites, or a mixture of crystallites and crystals. With regard to the content of crystals and/or crystallites in the glass, the emphasis in the present context will thus always be on the total content of the crystalline phases encompassed by a glass.

A glass is generally understood to mean an inorganic, nonmetallic, oxidic product that has been produced from a melting process and is at least partly in amorphous form, especially x-ray-amorphous form. However, the glass provided according to the present disclosure may also include crystals or crystallites, or crystalline phases in general, i.e. take the form of an at least partly crystallized glass.

The only low content of crystalline phases, i.e. crystals and/or crystallites, in the glass provided according to embodiments can firstly facilitate the production of a joining connection and correspondingly also of a feedthrough. For example, it is unnecessary for a nucleation step to be conducted in the fusing. In addition, it has even been found that simplified modes of assembly are possible in this way, i.e. especially with a glass provided according to embodiments that can have only low volume crystallization. For example, it is even possible to produce the electrically insulating component directly, i.e. without a grinding operation that follows the melting of the glass, followed by production of a compact composed of or comprising a glass powder. This is because it has been found that it may even be possible with glasses provided according to embodiments to obtain an electrically insulating component comprising or even composed of glass directly in a shaping process in the form, for example, of a tube drawing operation. This is advantageously possible because the glass provided according to the disclosure has only a very low tendency to crystallization. It has been found that, surprisingly, in spite of the lack of crystallites and/or crystals in the glass, nevertheless a high strength of the resulting joining connection, as manifested, for example, in a high glass pushout force, especially a high maximum glass pushout force value, optionally also for low vitrification lengths of only 3 mm, as described above. Especially for production of centrosymmetric designs of the electrically insulating component, the glass provided according to embodiments may therefore be particularly advantageous since, in this case, by the production of a glass tube, the geometric dimensions of which already correspond essentially to those of a later electrically insulating component, it is possible even after the melting and shaping to obtain a blank of the electronically insulating component without any need for grinding and pressing steps.

This may also be advantageous especially because, in the case of such a high pushout force, the overall result is particularly good mechanical resistance or strength of the joining connection, such that such a joining connection can also be used, for example, in a feedthrough and/or especially also in or for components subject to particular mechanical stress, for example airbag igniters.

Advantageously, this configuration of the joining connection or of a feedthrough according to embodiments and/or facilitated production of such a joining connection and/or feedthrough may be further assisted by a suitable selection of the joining partners and/or the glass.

Although it may be preferable in the present context when the glass comprises only a low level of crystalline phases, as set out above, it is also possible that the glass has a high content of crystalline phases. A high content of crystalline phases in a glass provided according to embodiments can be achieved, for example, in a joining connection comprising this glass, for example, when the electrically insulating component is produced by a sintering route. This is because, in this case, the grain boundaries in a compact, as is well known, are the starting point for crystallization. If, by contrast, a different shaping method is used, for example pipe drawing, it may possibly also be possible to achieve lower degrees of crystallization for the same glass composition.

In some embodiments, the glass further comprises at least one network transformer, NW, of the general formula R₂O, where a network transformer NW of the general formula R₂O is especially understood to mean an alkali metal oxide. In particular, the network transformer R₂O may thus be or comprise Na₂O, Li₂O, Cs₂O, K₂O, Rb₂O and any mixtures thereof, especially Na₂O, K₂O, Li₂O and any mixtures. Such a configuration with glass comprising at least one network transformer NW may be advantageous since, in this way, it is possible to lower the melting point on the part of the glass and hence to simplify the production of the glass. It is also possible by the addition of at least one network transformer, especially one alkali metal oxide or two or more alkali metal oxides, to increase the coefficient of thermal expansion of the resulting glass, which is particularly advantageous when the coefficient of thermal expansion is to have particularly good agreement with that of a metallic joining partner. This is because, in general, metallic materials, by comparison with a glass, have relatively high coefficients of thermal expansion. The coefficient of thermal expansion, in the context of the present disclosure, especially in relation to vitreous materials, is understood to mean the coefficient of linear thermal expansion a, which can especially be determined within a temperature interval between 20° C. and 300° C.

In some embodiments:
the sum total of all metal oxides or semimetal oxides, GB, of the general formula RO₂ or R₂O₃ that are encompassed by the glass is at least 50 mol % to optionally at most 70 mol %; and/or
the sum total of all network transformers, NW, of the general formula R₂O that are encompassed by the glass is from at least 9 mol % to at most 20 mol %, optionally from at least 10 mol % to optionally at most 19 mol %; and/or
the sum total of all metal oxides of the general formula MO that are encompassed by the glass is more than 15 mol % to optionally at most 35 mol %.

In this embodiment, the content of at least one component or group of components, i.e. therefore at least of the glass formers GB and/or of the metal oxides MO and/or of the network transformers MW, is thus within a particular range.

In some embodiments, for example, the sum total of all metal oxides or semimetal oxides, GB, of the general formula RO₂ or R₂O₃ that are encompassed by the glass is at least 50 mol % to optionally at most 70 mol %. In other words, this means that the glass in the present context in some embodiments is one in which the content of the glass formers is relatively low. At at least 50 mol %, the content of glass formers GB chosen is sufficiently high that a vitreous network can form, but is relatively low by comparison with known glasses and is optionally at most 70 mol %. A relatively low content of glass formers in a glass can be advantageous especially for lowering of the melting temperature, since the viscosity generally also rises with the content of glass formers, which are of course advantageous for formation of a stable, especially three-dimensionally linked, network. However, a low content of glass formers in a glass is also unfavorable for glass stability since the degree of crystallization also falls with increasing degree of crosslinking and rising viscosity. Nevertheless, the inventors have found that, surprisingly, it is nevertheless also possible with such a glass, which, in some embodiments, has a comparatively low glass former content, to produce a stable glass having only low crystallization, i.e. in particular only a small content of crystals and/or crystallites of optionally not more than 2% to 3% by volume, or even in essentially or even entirely crystallite-free form. This is apparently enabled by the favorable ratio of the sum total of the metal oxides to the sum total of the glass formers, as specified above.

It is advantageous in a further embodiment when the sum total of all metal oxides of the general formula MO that are encompassed by the glass is more than 15 mol % and optionally to at most 35 mol %. In this way, it is not only possible to establish the advantageous ratio of the metal oxides MO to the glass formers encompassed by the glass, which leads to formation of the advantageous solid glass with only a low volume crystallization of the glass or of the joining connection or feedthrough provided according to the disclosure. The inventors also suspect that what is obtained in this way is a particularly good glass structure similar to what is called an “invert glass” that has astonishingly good elastic properties that surprisingly lead to a good glass pushout force. In some embodiments, the content the sum total of all metal oxides of the general formula MO encompassed by the glass is more than 18 mol %. An exemplary upper limit for the sum total of all metal oxides of the general formula MO encompassed by the glass, in some embodiments, may be 31 mol %.

In a further embodiment, it may also be the case that the sum total of all network transformers, NW, of the general formula R₂O that are encompassed by the glass is from at least 9 mol % to at most 20 mol %, optionally from at least 10 mol % to optionally at most 19 mol %.

This is advantageous since, in this way, the advantages of the network transformers advantageously come to bear, for example the increasing of the coefficient of thermal expansion and/or the lowering of the melt viscosity, but without there being predominant adverse effects or these being manifested excessively, for example too low a stability of the glass or insulating component and/or too low a use temperature of the resulting glass or joining connection and/or feedthrough.

In a further embodiment, the SiO₂ content of the glass in general, without restriction to a particular working example of the present disclosure, is at least 45 mol %, optionally at least 47 mol %, optionally at least 49 mol % and in particular at most 67 mol %, optionally at most 65 mol %, optionally at most 63 mol %, optionally at most 61 mol %. SiO₂ is a glass former and contributes in particular to the stability of the glass to devitrification in the glasses provided according to the present disclosure. Therefore, the SiO₂ content of the glass should not be too low and, in some embodiments, is at least 45 mol %, optionally at least 47 mol %, optionally at least 49 mol %. However, the SiO₂ content of the glass is optionally limited, especially also in order that melting temperatures and/or melt viscosities attained are not too high. Therefore, in a further embodiment, the content of the glass is at most 63 mol %, optionally at most 61 mol %.

It has been found that, surprisingly, in spite of a relatively low content of SiO₂, it is possible to obtain a glass that enables sufficient strength in a joining connection. The glasses provided according to embodiments, in spite of the comparatively low content of network formers in general and of SiO₂ in particular, have only a very low tendency to crystallization, which is manifested in particular in the low contents of crystals and/or crystallites in the glass provided according to embodiments. As stated, the content thereof is optionally at most 3% by volume, optionally even at most 2% by volume, optionally at most 1% by volume, and it is even possible and may even be preferred for the glass to be free of crystals or crystallites.

In a further embodiment, the Na₂O content of the glass in general, without restriction to a particular working example of the present disclosure, is at least 2 mol %, optionally at least 4 mol %, and optionally at most 12 mol %, optionally at most 11 mol %, optionally at most 10 mol %. Being an alkali metal oxide, Na₂O acts as a network transformer in the glass provided according to the present disclosure and can therefore advantageously affect the coefficient of thermal expansion and the viscosity of the glass melt. Furthermore, Na₂O is a known and readily available glass component and therefore enables inexpensive production of a glass in a simple manner. However, it is known that Na₂O can adversely affect the chemical stability of a glass, and so the Na₂O content of the glass is optionally limited. The glass therefore optionally comprises at most 12 mol %, optionally at most 11 mol %, optionally at most 10 mol %. The minimum Na₂O content of the glass, in some embodiments, should be at least 2 mol %, optionally at least 4 mol %.

K₂O is a further component of the glass in some embodiments. The K₂O content of the glass may generally be, without restriction to a particular working example of the present disclosure, at least 2 mol %, optionally at least 3 mol %, and optionally at most 12 mol %, optionally at most 11 mol % and optionally at most 10 mol %.

Al₂O₃ is considered to be a glass former in the glasses provided according to embodiments and, in embodiments, is an optional component of a glass for a joining connection. The glass optionally comprises less than 4.5 mol % Al₂O₃, optionally less than 4 mol %, optionally at most 3 mol %. Al₂O₃ is a component that can increase the stiffness of a sealing glass. However, it has been found that, surprisingly, for the achievement of a sufficient strength of a joining connection, for example such that very high glass pushout forces are achievable, the Al₂O₃ content of the glass should advantageously not be too high and, according to embodiments, is optionally limited to at most 4.5 mol %. It is suspected that, in the glasses provided according to embodiments of the joining connections provided according to the present disclosure, especially with high pushout resistance and/or suitable for an airbag igniter or for feedthroughs for one of these, it is not absolutely necessary to use a particularly stiff glass. In particular, it is not necessary to obtain a glass having a particularly high modulus of elasticity. Instead, it appears to be advantageous when the result is an elastic glass network, where the content of glass formers in particular is limited as stated. But in particular, the nature of the glass formers involved also appears to be of significance. Advantageously, therefore, according to embodiments, as stated, the Al₂O₃ content of the glass should be correspondingly limited

B₂O₃ is a further optional component of a glass provided according to embodiments. B₂O₃ is a known glass former that can be used, for example, to lower the melting temperature of a glass, and is also advantageous with regard to chemical stability. Therefore, the glasses provided according to embodiments may comprise B₂O₃. However, an excessively high B₂O₃ content of a glass can generally the thermal stability thereof, and the content in the glass provided according to embodiments is therefore optionally limited. The B₂O₃ content of the glass is optionally less than 8 mol %, optionally less than 6 mol %, optionally less than 5, optionally less than 4.5. In this way, according to some embodiments, a good compromise can between good meltability of the glass, good chemical stability and good thermal stability of the glass overall and correspondingly of a joining connection comprising said glass.

BaO is a further optional component of a glass in accordance with embodiments. In the present context, BaO may be present as alkaline earth metal oxide in the glass and hence support the advantageous properties of the glass provided according to embodiments for creation of a particularly firm joining connection. However, the BaO content of the glass provided according to embodiments is optionally limited. This is because BaO, especially in excessively high contents, can lead to separation and/or crystallization of a glass. It has also been observed that, in the glasses provided according to embodiments, an excessively high BaO content can lead to increased bubble formation, which could possibly be attributed to the uptake of CO₂ by BaO. There is also discussion of potential water endangerment by BaO, and it should therefore not be encompassed in excessively high contents since leaching could possibly lead to water endangerment. Therefore, the BaO content of the glass provided according to embodiments is optionally at most 10 mol %, optionally not more than 6 mol %.

MgO is a further optional component of the glass provided according to some embodiments. The MgO content of the glass should optionally be less than 12 mol %, optionally at most 11 mol %. It has thus been shown that, in the case of an excessively high MgO content of the glass, there is a significant tendency to crystallization, which leads to only poor fusing. Therefore, as stated, the MgO content of the glass is optionally limited as stated above.

SrO is yet a further optional component of the glass provided according to some embodiments. The glass can optionally comprise not more than 12 mol % of SrO, since, in the case of this alkaline earth metal oxide too, a significant tendency to crystallization could be observed in the glasses of the disclosure. The glass optionally comprises at most 9 mol % of SrO.

In further embodiments, the glass may comprise fluoride F⁻. However, this component is problematic since it can adversely affect the chemical and also electrolytic stability of the glass in excessively high concentrations. Optionally, therefore, the fluoride content of the glass is limited and is optionally less than 6 mol %, optionally less than 5 mol % and optionally less than 3 mol %.

For all the aforementioned optional components, it is possible that, in specific embodiments, the glass may also be free of each respective component, meaning that this component is encompassed by the respective glass only in the form of unavoidable traces with a content of not more than 500 ppm, based on weight.

In a further embodiment, the glass comprises the following components in mol % based on oxide:
SiO₂: 45-67, optionally 47 to 63
Al₂O₃: 0-4.5, optionally less than 4, optionally 0-3
B₂O₃: 0-less than 8, optionally less than 6, optionally less than 5, optionally less than 4.5
TiO₂: 0-10, optionally less than 8, optionally less than 7, optionally less than 6
ZrO₂: 0-5, optionally 0-3, optionally 0-2.5
La₂O₃: 0-5, optionally 0-4, optionally 0-3.5
Fe₂O₃: 0-2, optionally less than 1, optionally at most 0.5
Li₂O: 0-4, optionally 0-3
Na₂O: 2-12, optionally 4-11
K₂O: 2-12, optionally 3-11
ZnO: 0-30, optionally 0-25
MgO: 0-less than 12, optionally 0-11
CaO: 0-22, optionally 0-17
SrO: 0-12, optionally 0-9
BaO: 0-10, optionally at most 6
Fluoride: 0-less than 6, optionally less than 5, optionally less than 3.

It has been found that, specifically in the combination of the aforementioned components as constituents of a glass, especially in the aforementioned ranges, a joining connection can be obtained that surprisingly has particularly high strength, for example also determined as glass pushout force, as described above in general terms for all embodiments.

With a glass provided according to a composition as detailed above, it is especially possible to achieve only low volume crystallization, for example of at most 3% by volume or less, generally between at most 2-3% by volume or less, for example 1% by volume or less, or even essentially or completely crystallite-free glasses. What is surprising in particular is that even with such an amorphous microstructure, i.e. with a proportion by volume of crystallites and/or crystals in the glass of at most 3% by volume or even less, as stated above, a joining connection provided according to embodiments is possible with very high strength, for example glass pushout resistance. This is because it had been assumed to date that, for such particularly firm joining connections as can be used, for example, in small feedthroughs, for example including in an airbag igniter or similar applications, achievement of high strengths required microstructures comprising crystals and/or crystallites, specifically also with interlocked and interdigitated crystals and/or crystallites, in order to achieve such high strength. The inventors suspect that the high strengths which in spite of the low volume crystallization and in particular also with glasses provided according to embodiments that comprise only very few crystals or crystallites or else may optionally be in essentially crystallite-free form can firstly be attributed to particularly good chemical binding between the glass and at least one joining partner or else optionally two or more or all joining partners encompassed by the joining connection. It would be possible to achieve this, for example, in that the glass, by virtue of the relatively low SiO₂ content, has a comparatively low melt viscosity, such that good adaptation of the glass is enabled. Secondly, this could alternatively or additionally be the result of enabling, in the glass structures obtained with preference with the glasses provided according to embodiments, a particularly good glass structure which is able to provide particularly good compensation, for example, under compressive stresses such as those that act on the glass or a joining connection in pressing out the glass. However, the relationships that possibly underlie this possible mechanism are not fully understood.

In some embodiments, the glass and/or the electrically insulating component has a coefficient of linear thermal expansion, α₂₀₋₃₀₀, in the range from 20° C. to 300° C., of more than 7.5*10⁻⁶/K, optionally more than 8*10⁻⁶/K, and optionally of at most 12*10⁻⁶/K, optionally of at most 11*10⁻⁶ K. It is possible that the component to be joined, or the materials encompassed by these components, are chosen such that there is only a very small difference in their coefficients of thermal expansion. In this way, it is possible, for example, to achieve particularly low-stress fusions. However, it is also possible and may also be advantageous for particular applications that the coefficients of thermal expansion of the joining partners differ in a controlled manner from the coefficient of thermal expansion of the insulating component, especially of the glass encompassed by this component. In this way, it is especially possible to establish what is called a pressure vitrification.

In the context of the present disclosure, the coefficient of thermal expansion is understood to mean the coefficient of linear thermal expansion a. Unless stated otherwise, it is quoted in the range of 20-300° C. The symbols a and α₂₀₋₃₀₀ are used synonymously in the context of this invention. The stated value is the nominal average coefficient of linear thermal expansion according to ISO 7991, which is determined in a static measurement.

In a further embodiment, the glass has a processing temperature Va of less than 1000° C.

Alternatively or additionally, the glass may have a softening temperature Ew of less than 800° C., optionally less than 770° C.

Va denotes the processing point, the temperature at which the viscosity of the glass is 10⁴ dPa*s (called T 4). EW denotes the softening point, namely T 7.6, the temperature at which the viscosity of the glass is 10^{7.6} dPa*s.

Such configurations of the glass provided according to embodiments may be very advantageous since glasses having such a processing temperature and/or such a softening temperature achieve good wetting of the joining partner(s) by the glass in the glazing process (or, synonymously, vitrification process). The glasses thus melt efficiently, which is especially understood to mean that the glasses optionally form positive meniscuses, especially also if no external pressure is applied, for example by a graphite die.

In yet a further embodiment, it is also possible that the electrically insulating component comprises a filler, for example a crystalline inorganic filler. A filler in the context of the present disclosure is understood to mean a further material added to the vitreous material, which is especially configured such that it reacts only to a very small degree, if at all, with the vitreous material, but is essentially inert with respect thereto. In that case, the electrically insulating component is therefore configured such that it comprises a composite material.

An addition of a filler may be advantageous, for example, when the coefficient of thermal expansion of the insulating component is to be adjusted accurately. For example, it is possible to add negatively expanding β-eucryptite to the glass, which leads to a lowering of the resulting coefficient of thermal expansion of the electrically insulating component.

Such a configuration of the joining connection in which the electrically insulating component comprises a composite material comprising a glass provided according to embodiments and at least one filler, optionally also two or more fillers, is appropriately associated with production of the electrically insulating component via a “powder route”; in other words, the glass here is produced as a ribbon, then ground up and then processed further to give compressible granules. This is then followed by further steps including, for example, production of a sintered blank.

In yet a further embodiment, the glass has a hydrolytic stability, determined according to ISO 719 (1994-02), of class 3 or better, optionally class 2 or better, optionally class 1. Such a configuration of the glass and/or of the joining connection configured with such a glass (and of a feedthrough comprising one) is very advantageous since a product having good corrosion resistance is obtained in this way. Such good corrosion resistance is important not only for products that are used in particularly corrosive environments but also for good long-term stability, for example when a product is stored in ambient air over a long period but nevertheless still has to function reliably even after a long period.

In a further embodiment, the glass has an alkali resistance according to ISO 695 (1989-12) of 2 or better, optionally of 1. The alkali resistance of a glass is a further aspect of the corrosion resistance of a glass, and a high alkali stability can therefore advantageously further improve the overall corrosion resistance of the glass and of a product comprising such a glass.

The glass astonishingly has this in spite of a comparatively low proportion of glass formers overall, especially of SiO₂ and also especially of B₂O₃. Specifically glasses having a high content of SiO₂ and advantageously also a high content of B₂O₃ are known to have particularly high corrosion resistance, and so the good corrosion properties of the glass provided according to embodiments can therefore be classified as being quite surprising.

In some embodiments, the glass has a modulus of elasticity of at least 70 GPa. However, the modulus of elasticity is optionally limited and has a value of at most 95 GPa.

In a further embodiment, the glass is free of components of toxicological concern, especially of PbO, As₂O₃, CdO, SeO₂, free of these components being understood to mean that the glass comprises these components only in the form of impurities having a content of in each case not more than 500 ppm, especially of in each case not more than 100 ppm, based on weight. The glass is thus optionally producible without components of toxicological concern.

In a further embodiment, the glass comprises refining agents, especially Sb₂O₃, sulfates and/or chlorides, merely in the form of impurities with a content of in each case not more than 500 ppm, based on weight. Use of refining agents is thus not absolutely necessary, and so there is no need, for example, for materials that pose a concern to health and/or materials that may attack the tank blocks.

In a further embodiment, the glass comprises coloring additions, especially compounds of Co, Ni, Cr, Cu, Mn, Mo, V or W and/or compounds of the rare earths, for example compounds of Ce, Nd or Eu, merely in the form of impurities having a content of in each case at most 500 ppm, based on weight.

Some literature ascribes an adhesion-promoting effect to these materials and components. However, it has been found that, in the case of the glasses provided according to embodiments, there is no need for such materials for establishment of a good and firm joining connection between the insulating component and the joining partner or, if appropriate, two or more joining partners, and so the glass provided according to embodiments does not need these components. This is advantageous since some of these components are also quite costly.

In yet a further embodiment, the glass is free of Bi₂O₃, TeO₂, GeO₂, Ta₂O₅, Nb₂O₅, Ga₂O₃, Y₂O₃, InO₂, free of these components being understood to mean that the glass comprises these components only in the form of impurities having a content of in each case not more than 500 ppm, based on weight. In other words, the glass provided according to embodiments can be produced without the use of high-purity raw materials; it is thus advantageously unnecessary to use components that require high-purity and/or costly raw materials.

In some embodiments, at least one joining partner comprises a metal, especially a metal from the group of the steels, for example the normal steels, stainless steels, nonrusting steels and high-temperature-stable ferritic steels, which are also known by the Thermax brand name, for example Thermax4016, Thermax4742, or Thermax4762 or Crofer22 APU or CroFer22 H or NiFe-based materials, for example NiFe45, NiFe47 or nickel-plated pins, or known by the Inconel brand name, for example Inconel 718 or X-750, or steels known, for example, by the CF25, Alloy 600, Alloy 625, Alloy 690, SUS310S, SUS430, SUH446 or SUS316 names, or austenitic steels such as 1.4828 or 1.4841 or a high-temperature-stable ceramic compound, for example an alumina-based ceramic or a zirconia-based ceramic, for example a ceramic comprising Y-stabilized zirconia.

With these materials, advantageously, not only are mechanically high-strength joining connections achievable, but it is in particular also possible that the joining connection obtained can also withstand higher temperatures, for example of up to 500° C., particularly advantageously in such a way that the mechanical strength of the joining connection is maintained even at these elevated temperatures. This is particularly advantageous for use of the joining connection and/or of a feedthrough comprising such a joining connection, for example in an airbag igniter or in a sensor, such as an exhaust gas sensor, a pressure sensor, a particle sensor, for example a soot particle sensor and/or a temperature sensor, and/or in an NO sensor and/or in an oxygen sensor, and/or in a feedthrough for a compressor and/or an e-compressor and/or as an electrical bushing in an exhaust gas element and/or in a fuel cell and/or in a feedthrough for a chemical reactor. This is because there may be high mechanical compressive stresses here acting on the insulating component, i.e. the glass, and use temperatures are also simultaneously high.

In some embodiments, one joining partner is designed as a base comprising at least one passage opening, and wherein the base has a height of at most 10 mm and at least 0.5 mm, optionally of at most 5 mm and at least 1.5 mm. In this way, it is possible to produce a compact design of the joining connection and of a feedthrough comprising one, nevertheless surprisingly resulting in high-strength joining connections.

In addition, the present disclosure also relates to a method of producing a joining connection, especially a high-strength joining connection, especially a joining connection for an airbag igniter or suitable for a feedthrough for an airbag igniter, especially optionally a joining connection provided according to the above-described embodiments.

The method comprises the following steps:
melting a glass, especially a glass provided according to embodiments as described above,
producing ribbons and/or fits from the or comprising the glass, wherein the ribbons and/or frits are ground to powder and processed to give compressible granules, or hot forming to obtain a tube composed of or comprising the glass as preform,
optionally compressing the granules to obtain a preform,
assembling the preform with at least one joining partner,
transferring preform and at least one joining partner to a kiln to perform a thermal treatment, such that the glass adapts and a connection is formed between the glass and the at least one joining partner.

An exemplary embodiment is one in which the glass is hot formed to obtain a tube after the melting. This is because there is then no need for any further steps, for example grinding and granulating.

However, it may also be advantageous when the powder route is taken, i.e. ribbons and/or frits are produced and ground to powder and granulated. This is because it is possible in this case to include, for example, fillers or at least one filler in the processing, for example for exact adjustment of a coefficient of expansion.

The thermal treatment can be effected, for example, at temperatures between 850° C. and 1000° C., especially in an industrial vitrification kiln.

Joining connections provided according to the present disclosure, for example produced or producible as described above and/or comprising a glass provided according to embodiments, are typically also cleaned, for example electrolytically cleaned. The joining connections provided according to embodiments optionally withstand this without significant damage; in particular, the advantageous properties of the joining connection provided according to embodiments are still achieved thereafter.

The present disclosure also relates to a joining connection produced or producible in a method as described above and/or comprising a glass provided according to above-described embodiments.

In addition, the present disclosure also relates to a feedthrough comprising a joining connection provided according to embodiments and/or produced or producible in a method according to embodiments and/or comprising a glass provided according to embodiments.

In addition, the present disclosure also relates to the use of a joining connection provided according to embodiments and/or produced or producible in a method according to embodiments, and/or the use of a feedthrough according to embodiments, in an airbag igniter or in a sensor, such as an exhaust gas sensor, a pressure sensor, a particle sensor, for example a soot particle sensor, and/or a temperature sensor and/or in an NO sensor and/or in an oxygen sensor, and/or in a feedthrough for a compressor and/or an e-compressor and/or as an electrical bushing in an exhaust gas element and/or in a fuel cell and/or in a feedthrough for a chemical reactor.

In addition, the present disclosure especially also relates to an airbag igniter comprising a feedthrough, especially a feedthrough provided according to embodiments, and/or a joining connection, especially a joining connection provided according to embodiments and/or produced or producible in a method provided according to embodiments, comprising a glass, especially a glass provided according to embodiments, wherein the joining connection has a maximum value of the glass pushout force, optionally determined for a vitrification length of 3 mm or up to 3 mm, but of at least 0.5 mm, of more than 3900 N, optionally at least 4000 N, optionally determined as the average pushout force for an entirety of 12 to 25 joining connections.

### Examples

The invention is elucidated in more detail hereinafter by examples.

The tables that follow list compositions of glasses provided according to embodiments. The compositions are each reported in mol %. The characteristic temperatures are the temperatures typically used for description of the melting characteristics of ashes, such as softening temperature (abbreviation: soften), sintering temperature (abbreviation: sinter), sphere temperature (abbreviation: sphere), hemisphere temperature (abbreviation: hemisphere) and flow temperature (abbreviation: flow), as determined by a heating microscope (abbreviation: EHM). These temperatures are ascertained in accordance with or on the basis of DIN 51730. The coefficient of thermal expansion a for the range of 20° C. to 300° C. is reported in each case in units of 10⁻⁶/K and is also referred to hereinafter as “CTE”. tₖ 100 reports the temperature of the glass for a specific electrical resistivity of 10⁸ Ω*cm, optionally determined according to DIN 52326. The abbreviations P1 to P3 represent temperature programs, where P1 is a temperature program for fusing, i.e. for the forming of a bond between the glass and at least one joining partner, for example a cohesive bond, where the glass optionally melts on fusion and optionally wets the at least one joining partner, with a maximum temperature between 870° C. and 900° C., optionally 885° C., P2 is a second temperature program with a maximum temperature between 905° C. and 935° C., optionally 920° C., and P3 is a third temperature program with a maximum temperature between 940° C. and 980° C., optionally 960° C. Specific resistivity is abbreviated to “spec. r.”. T g represents the glass transition temperature, determined via the point of intersection of the tangents on the two branches of the expansion curve on measurement at a heating rate of 5 K/min. This corresponds to a measurement according to ISO 7884-8 or DIN 52324. Va denotes the processing point, the temperature at which the viscosity of the glass is 10⁴ dPa*s (called T 4). EW denotes the softening point, namely T 7.6.

TABLE 1

| | Ex. 1 | Ex. 2 | Ex. 3 | Ex. 4 | Ex. 5 | Ex. 6 | Ex. 7 | Ex. 8 |
|---|---|---|---|---|---|---|---|---|
| | mol % | mol % | mol % | mol % | mol % | mol % | mol % | mol % |
| Component | | | | | | | | |
| SiO₂ | 59.8 | 56.1 | 56.75 | 54.45 | 60.45 | 56.25 | 55.45 | 52.5 |
| Al₂O₃ | 0.05 | 0.5 | 0.3 | | | 0.8 | 0.8 | 1.95 |
| B₂O₃ | | 2.8 | 1.95 | 4.2 | | 0.3 | 0.25 | |
| TiO₂ | | 4.7 | 3.3 | | | 4.0 | 2.7 | |
| ZrO₂ | 2.1 | | 0.3 | 1.9 | | | | 1.95 |
| P₂O₅ | | 0.01 | 0.01 | | | | 0.01 | |
| Fe₂O₃ | | 0.8 | 0.45 | | | 0.35 | 0.4 | |
| La₂O₃ | 2.0 | | | 2.0 | 2.95 | | | |
| Li₂O | 1.9 | | | | | | | |
| Na₂O | 8.25 | 6.15 | 5.2 | 6.15 | 8.2 | 7.8 | 8.5 | 8.35 |
| K₂O | 5.05 | 8.15 | 9.0 | 6.15 | 5.2 | 5.2 | 5.1 | 8.45 |
| ZnO | 20.1 | | 10.35 | 7.05 | 23.2 | 11.2 | 11.7 | 10.8 |
| MgO | | 0.1 | 0.05 | | | 7.0 | 7.0 | |
| CaO | | 15.7 | 7.6 | 8.1 | | 7.0 | 7.1 | 16.0 |
| SrO | | 0.1 | | 7.5 | | | | |
| BaO | 0.5 | 4.9 | 4.8 | 0.05 | | | | |
| F | 0.25 | | | 2.45 | | | | |
| Cl | | | | | | 0.05 | 1 | |
| Total | 100.0 | 100.0 | 100.0 | 100.0 | 100.0 | 100.0 | 100.0 | 100.0 |
| Σ GB | 64.0 | 64.9 | 63.1 | 62.6 | 63.4 | 61.8 | 59.6 | 56.4 |
| (RO₂ + R₂O₃) | | | | | | | | |
| Σ R₂O | 15.2 | 14.3 | 14.2 | 12.3 | 13.4 | 13.0 | 13.6 | 16.8 |
| Σ MO (RO) | 20.6 | 20.8 | 22.8 | 22.7 | 23.2 | 25.2 | 25.8 | 26.8 |
| MO/GB | 0.32 | 0.32 | 0.36 | 0.36 | 0.37 | 0.41 | 0.43 | 0.48 |
| Vit. length [mm] | 1.9 | 2.6 | 2.6 | 1.45 | 1.2 | 2.4 | 2.1 | 1.6 |
| Number of | | 35 | 35 | 15 | 15 | 35 | | 15 |
| samples | | | | | | | | |
| Glass pushout | | | | | | | | |
| force [kN] | | | | | | | | |
| P1 [kN] | | | 4.45 | 4.1 | 4.1 | 4.45 | | 4.3 |
| P2 [kN] | 4.3 | 4.1 | | | | 4.7 | 4.2 | |
| P3 [KN] | 4.2 | | | | | | | |
| CTE [10⁻⁶/K] | 8.10 | 10.50 | 10.15 | 9.65 | 8.60 | | 9.6 | 10.55 |
| Density [g/cm³] | 3.11 | 2.84 | 2.94 | 3.10 | 3.17 | | 2.82 | 2.87 |
| Tg [° C.] | 541 | 554 | 545 | 544 | 576 | | 542 | 555 |
| T13 [° C.] | | 554 | 543 | 558 | 586 | | 552 | 572 |
| EW (T. 7.6) [° C.] | 704 | 686 | 691 | 701 | 728 | | 693 | 708 |
| Va (T. 4) [° C.] | 952 | 885 | 910 | 917 | 955 | | 915 | 928 |
| ALKALI ISO695 | A1 | A2 | A2 | A1 | A1 | | A2 | A1 |
| WATER ISO719 | HGB 1 | | HGB 2-3 | HGB 2 | HGB 1 | | HGB 2-3 | HGB 3 |
| MoE [GPa] | 81 | 80 | 75 | 83 | 77 | | | 82 |
| tk100 [° C.] | 308 | 394 | 371 | 417 | 300 | | 300 | 332 |
| lg spec. r. 350° C. | 9.2 | 5.09 | 8.34 | 9.06 | 7.23 | | 7.2 | 9.61 |
| lg spec. r. 250° C. | 7.5 | 10.74 | 10.31 | 11.17 | 8.91 | | 8.95 | 7.7 |
| Temperatures | | | | | | | | |
| [° C.] | | | | | | | | |
| EHM: sinter | | 539 | 563 | 560 | 586 | 571 | 558 | 564 |
| EHM: soften | | 709 | 729 | 733 | 747 | 640 | 706 | 720 |
| EHM: sphere | | 742 | 747 | 754 | 782 | | 749 | 780 |
| EHM: | | 838 | 851 | 919 | 1006 | 877 | 857 | 934 |
| hemisphere | | | | | | | | |
| EHM: flow temp. | | 927 | 937 | 986 | 1067 | 1035 | 1001 | 1074 |

TABLE 2

| | Ex. 9 | Ex. 10 | Ex. 11 | Ex. 12 | Ex. 13 | Ex. 14 |
|---|---|---|---|---|---|---|
| | mol % | mol % | mol % | mol % | mol % | mol % |
| Component | | | | | | |
| SiO₂ | 57.6 | 57.0 | 56.9 | 57.9 | 49.7 | 56.7 |
| Al₂O₃ | 0.7 | 0.45 | 0.70 | 0.05 | 2.4 | 0.85 |
| B₂O₃ | 0.4 | 0.60 | 0.15 | 3.60 | 0.2 | 0.4 |
| TiO₂ | 4.6 | 4.45 | 4.85 | 4.30 | 3.7 | 4.1 |
| ZrO₂ | | 0.15 | 0.10 | 1.10 | | |
| P₂O₅ | | | 0.2 | | | 0.01 |
| Fe₂O₃ | | | | 0.65 | | 0.01 |
| La₂O₃ | | | | | | |
| Li₂O | | 0.6 | | | 2.5 | |
| Na₂O | 8.85 | 7.60 | 7.90 | 5.65 | 7.9 | 7.4 |
| K₂O | 4.65 | 5.05 | 5.30 | 6.75 | 3.9 | 5.2 |
| ZnO | 7.3 | 12.2 | 10.7 | 4.3 | 9.3 | 11.2 |
| MgO | 8.0 | 5.9 | 6.5 | 2.0 | 10.2 | 7.0 |
| CaO | 8.0 | 6.0 | 6.7 | 13.7 | 10.2 | 7.3 |
| SrO | | | | | | |
| BaO | | | | | | |
| F | | | | | | |
| Cl | | | | | | |
| Total | 100.0 | 100.0 | 100.0 | 100.0 | 100.0 | 100.0 |
| Σ GB | 63.2 | 62.7 | 62.9 | 67.6 | 56.0 | 62.0 |
| (RO₂ + R₂O₃) | | | | | | |
| Σ R₂O | 13.5 | 13.3 | 13.2 | 12.4 | 14.3 | 12.6 |
| Σ MO (RO) | 23.3 | 24.1 | 23.9 | 20.0 | 29.7 | 25.4 |
| MO/GB | 0.37 | 0.38 | 0.38 | 0.30 | 0.53 | 0.41 |
| Vit. length [mm] | 2.4 | 2.4 | 2.1 | 2.1 | 1.9 | |
| Number of | 30 | 30 | 30 | 30 | 30 | |
| samples | | | | | | |
| Glass pushout | | | | | | |
| force [kN] | | | | | | |
| P1 [kN] | 4.85 | 4 | 4.2 | 3.91 | 3.91 | |
| P2 [kN] | 4.8 | | 3.9 | | | |
| P3 [kN] | | | | | | |
| CTE [10⁻⁶/K] | 9.55 | 8.20 | 9.45 | 9.2 | 9.8 | 9.24 |
| Density [g/cm³] | 2.76 | 2.84 | 2.85 | 2.74 | 2.87 | 2.82 |
| Tg [° C.] | 556 | 542 | 559 | 576 | | 555 |
| T13 [° C.] | | | | 574 | | |
| EW (T. 7.6) [° C.] | | | | 719 | | 708 |
| Va (T. 4) [° C.] | | | | 929 | | 922 |
| ALKALI ISO695 | A2 | A2 | A2 | A1-A2 | A2 | A2 |
| WATER ISO719 | HGB 3 | HGB 2 | HGB 2 | HGB 3 | HGB 2-3 | HGB 2 |
| MoE [GPa] | 81 | | 81 | 81 | 89 | 80 |
| tk100 [° C.] | 305 | 327 | 320 | 374 | 353 | |
| lg spec. r. 350° C. | 7.28 | 7.63 | 7.53 | 8.36 | 8.06 | |
| lg spec. r. 250° C. | 9.03 | 9.48 | 9.32 | 10.25 | 10.11 | |
| Temperatures | | | | | | |
| [° C.] | | | | | | |
| EHM: sinter | 602 | 563 | 580 | 595 | 541 | |
| EHM: soften | 743 | | 714 | 741 | 674 | |
| EHM: sphere | 766 | 752 | 765 | 780 | 725 | |
| EHM: | 873 | 861 | 862 | 877 | 970 | |
| hemisphere | | | | | | |
| EHM: flow temp. | 1024 | 962 | 989 | 980 | 995 | |

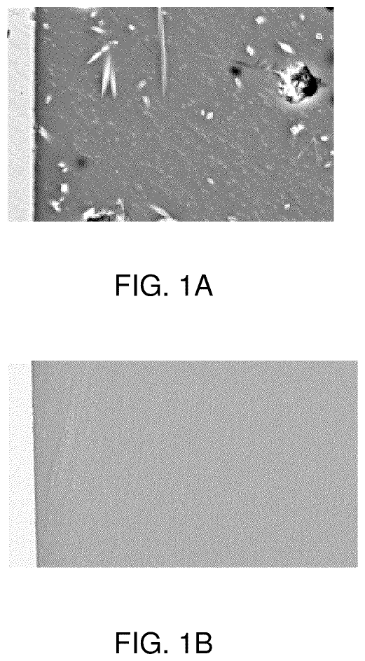

It is possible to produce preforms from working example 1 either by the pipe drawing method or via the sintering route. Surprisingly, the result for the pushout force of the joining connections produced with these different preforms is the same. Microstructure images can be found in FIGS. 1A and 1B; FIG. 1A shows, in 2000× magnification, the microstructure image of the preform obtained via the sintering route in the corresponding joining connection; FIG. 1B shows, in 1000× magnification, the microstructure of the preform obtained by pipe drawing in the corresponding joining connection. The joining partner is always shown on the left-hand side in the microstructure images of FIGS. 1A and 1B. In this case, the microstructure of FIGS. 1A and 1B is a metal.

This is all the more surprising because the microstructure of the preforms of this glass that are produced via sintering have acicular crystallization (see also FIG. 1A).

Comparative examples are detailed hereinafter in the two tables below. The identification of the parameters and units corresponds to that for the working examples in tables 1 and 2.

TABLE 3

| | Comp 1 | Comp 2 | Comp 3 | Comp 4 | Comp 5 | Comp 6 | Comp 7 |
|---|---|---|---|---|---|---|---|
| | mol % | mol % | mol % | mol % | mol % | mol % | mol % |
| Component | | | | | | | |
| SiO₂ | 64.5 | 64.4 | 62.4 | 62.3 | 56.5 | 50.6 | 77.7 |
| Al₂O₃ | 3.05 | 1.3 | 0.6 | 2.4 | | 1.95 | 2.3 |
| B₂O₃ | 1 | | 1.0 | 2.2 | | | |
| TiO₂ | | | | | | 2.1 | |
| ZrO₂ | 1 | 2.8 | 1.9 | 1.0 | 1.9 | | |
| Fe₂O₃ | | | | | | 0.4 | |
| La₂O₃ | | | 0.6 | | | | |
| Li₂O | 1.2 | | 1.1 | 0.5 | | | 1.3 |
| Na₂O | 5.1 | 8.0 | 8.5 | 7.4 | 6.2 | 9.3 | 7.7 |
| K₂O | 7.7 | 8.1 | 4.7 | 5.0 | 8.1 | 7.1 | 5.2 |
| ZnO | 4.0 | 15.3 | 18.4 | 13.3 | 3.5 | 5.9 | |
| MgO | 9.9 | | | | | 12.0 | |
| CaO | 0.1 | | | 5.7 | 8.3 | 6.1 | |
| SrO | | | | | 15.5 | 3.9 | |
| BaO | | | | | 0.1 | 0.03 | 5.5 |
| F | 2.5 | | 0.8 | 0.3 | | | |
| Cl | | | | | | 0.7 | |
| Total | 100.0 | 99.9 | 100.0 | 100.0 | 100.0 | 100.0 | 99.7 |
| Σ GB | 69.6 | 68.5 | 66.5 | 67.9 | 58.4 | 55.1 | 80.0 |
| (RO₂ + R₂O₃) | | | | | | | |
| Σ R₂O | 14.0 | 16.1 | 14.3 | 12.9 | 14.3 | 16.4 | 14.2 |
| Σ MO (RO) | 13.9 | 15.3 | 18.4 | 18.9 | 27.4 | 27.9 | 5.5 |
| MO/GB | 0.20 | 0.22 | 0.28 | 0.28 | 0.47 | 0.51 | 0.07 |
| Vit. length [mm] | n.a. | 2.0 | 1.6 | 1.7 | 2.5 | 2.2 | 1.9 |
| Number of | | 35 | 15 | 15 | | 10 | 15 |
| samples | | | | | | | |
| Glass pushout | | | | | | | |
| force [kN] | | | | | | | |
| P1 [kN] | | | 3.15 | 2.6 | 3.5 | 3.2 | 2.7 |
| P2 [kN] | not | 2.75 | | 3.7 | 3.5 | | 2.75 |
| | melt. | | | | | | |
| P3 [KN] | 3.2 | 3.7 | | 3.7 | 1.8 | | 2.5 |
| CTE [10⁻⁶/K] | 8.75 | 9.45 | 8.55 | 8.60 | 10.9 | 10.8 | 9.30 |
| Density [g/cm³] | 2.55 | 2.78 | 2.93 | 2.83 | 3.03 | 2.82 | 2.61 |
| Tg [° C.] | 515 | 570 | 514 | 526 | 548 | 522 | 475 |
| T13 [° C.] | 531 | | | | | 532 | |
| EW (T. 7.6) [° C.] | 745 | 786 | | 699 | | 671 | |
| Va (T. 4) [° C.] | 1085 | 1067 | | | | 890 | |
| ALKALI ISO695 | | | | | | | |
| WATER ISO719 | | | | | HGB 3 | HGB 3 | HGB 4 |

TABLE 4

| | Comp 8 | Comp 9 | Comp 10 | Comp 11 | Comp 12 | Comp 13 | Comp 14 | |
|---|---|---|---|---|---|---|---|---|
| | mol % | mol % | mol % | mol % | mol % | mol % | mol % | Comp 15 |
| Component | | | | | | | | |
| SiO₂ | 49.8 | 43.8 | 39.1 | 74.2 | 69.0 | 34.4 | 58.3 | 57.0 |
| Al₂O₃ | 1.7 | | 3.1 | 2.5 | 2.8 | 2.0 | 4.05 | 0.1 |
| B₂O₃ | 2.4 | 1.0 | 1.1 | 2.0 | 1.0 | 4.9 | 1.95 | 7.9 |
| TiO₂ | | | | | | | | 1.5 |
| ZrO₂ | 3.2 | | | 1.4 | | | | |
| Fe₂O₃ | | | | 0.01 | | | | |
| La₂O₃ | 1.4 | 2.9 | 1.0 | | | | | |
| Li₂O | 0.8 | | | 1.8 | | | | |
| Na₂O | 7.1 | 8.2 | 6.4 | 8.6 | 10.8 | 7.1 | 7.1 | 2.3 |
| K₂O | 2.8 | 5.0 | 2.1 | 4.2 | 3.4 | | 6.9 | 5.8 |
| ZnO | 13.6 | 6.8 | 10.6 | | | 14.1 | 7.9 | |
| MgO | | | | 0.3 | | | 7.8 | 5.3 |
| CaO | 3.2 | 6.9 | 9.5 | 0.3 | 8.4 | 16.0 | 6.1 | 7.6 |
| SrO | 8.0 | 14.7 | 16.4 | 0.05 | | 12.4 | | 5.1 |
| BaO | 0.1 | 0.1 | 0.1 | 4.79 | 2.0 | 0.1 | | |
| F | 6.0 | 10.6 | 10.6 | | 2.6 | 9.0 | | |
| Cl | | | | 0.02 | | | | |
| Total | 100.0 | 100.0 | 100.0 | 100.0 | 100.0 | 100.0 | 100.0 | 100.0 |
| Σ GB | 58.4 | 47.7 | 44.3 | 80.0 | 72.8 | 41.3 | 64.3 | 66.5 |
| (RO₂ + R₂O₃) | | | | | | | | |
| Σ R₂O | 10.8 | 13.2 | 8.5 | 14.5 | 14.2 | 7.1 | 14.0 | 8.1 |
| Σ MO (RO) | 24.9 | 28.5 | 36.6 | 5.5 | 10.4 | 42.6 | 21.8 | 25.4 |
| MO/GB | 0.43 | 0.60 | 0.83 | 0.07 | 0.14 | 1.03 | 0.34 | 0.38 |
| Vit. length [mm] | 2.8 | — | — | 1.9 | 2.1 | 1.9 | 2.4 | |
| Number of | 15 | [5] | | 35 | 35 | | | |
| samples | | | | | | | | |
| Glass pushout | | | | | | | | |
| force [kN] | | | | | | | | |
| P1 [kN] | 2.6 | no | no | | | | 1.8 | |
| | | fusion | fusion | | | | | |
| P2 [kN] | | 1.35 | no | 3.9 | | 2.35 | | |
| | | | fusion | | | | | |
| P3 [kN] | | | | 3.5 | 3.5 | | | |
| CTE [10⁻⁶/K] | 8.70 | 8.60 | 10.45 | 8.60 | 9.47 | 10.24 | 9.25 | 8.87 |
| Density [g/cm³] | 3.22 | 3.38 | 3.38 | 2.64 | 2.57 | 3.39 | 2.66 | 2.92 |
| Tg [° C.] | 527 | 472 | 523 | 502 | 527 | 504 | 551 | 587 |
| T13 [° C.] | | 490 | 535 | 508 | | 513 | 562 | |
| EW (T. 7.6) [° C.] | 692 | 624 | 660 | 708 | 707 | 620 | 733 | |
| Va (T. 4) [° C.] | | 818 | 855 | 1046 | 1000 | 779 | 1009 | |
| ALKALI ISO695 | | | A3 | | | A3 | | |
| WATER ISO719 | | | | HGB 3 | HGB 3 | | | HGB 4 |

In the above table, no vitrification length is quoted for samples where there is no fusion and hence no vitrification length.

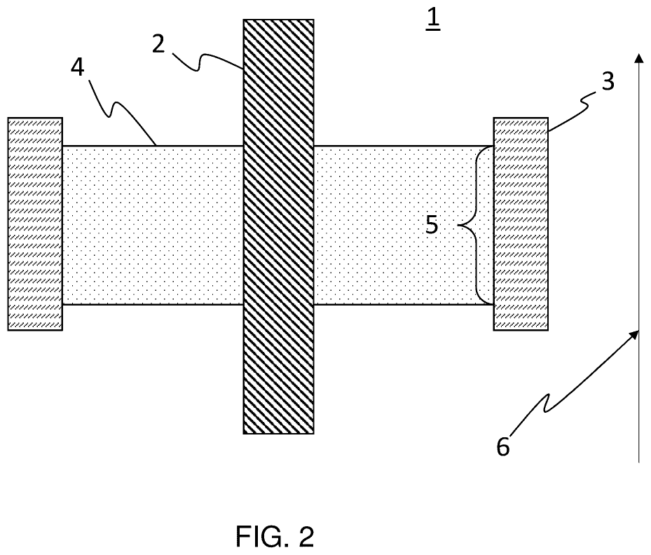

FIG. 2 shows, in a schematic diagram which is not true to scale, a joining connection provided according to embodiments. The joining connection 1 comprises an electrical component 4 and the joining partners 2, 3, which are kept electrically insulated from one another by the electrically insulating component 4. The electrically insulating component 4 comprises a glass, optionally a glass comprising not more than 2-3% by volume of crystals and/or crystallites, or may even consist of such a glass. It may be preferable for the glass to be an essentially crystallite-free glass. The vitrification length 5 is likewise identified. This is the shortest length of the interface formed in axial direction 6 between the electrically insulating component 4 and at least one joining partner 2, 3. The joining partner 3 here is in the form of a cavity having an opening that accommodates the joining partner 2 and the electrically insulating component 4. For example, it is generally possible for the joining partner 3, which can also be referred to as outer joining partner, to take the form of a round or cylindrical hollow body. In general, without restriction to one embodiment, the joining partner 2, which may also be referred to as inner joining partner, may be configured as a pin. Likewise identified is the so-called vitrification length 5. This is generally the shortest length of the interface between the electrically insulating component 4 and at least one joining partner of the joining connection in axial direction. Axial direction 6 is understood here to mean the direction aligned approximately parallel to the longitudinal extent of the joining partner 2, designed here as an elongated pin. Axial direction 6 may also be understood as the direction approximately perpendicular to the free surface of the electrically insulating component 4, where the free surface is that surface which is not in contact with one of joining partners 2, 3. Approximately parallel or approximately perpendicular is understood here to mean that the variance from an ideally parallel or perpendicular alignment is not more than ±10°, optionally not more than ±5°.

The vitrification length may thus also be regarded here as the lowest height of the electrical component 4. The vitrification length 5 is the same here on both joining partners 2, 3. However, it is alternatively possible that, because of meniscus formation, the vitrification length on joining partner 2 is shorter than on joining partner 3. In that case, the vitrification length 5 is the shorter length.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A joining connection for an airbag igniter, comprising:
an electrically insulating component comprising a glass; and
at least two joining partners, the at least two joining partners being kept electrically insulated from one another by the electrically insulating component.

2. The joining connection of claim 1, wherein the glass comprises not more than 2-3% by volume of crystals and/or crystallites.

3. The joining connection of claim 2, wherein the glass is essentially crystallite-free.

4. The joining connection of claim 1, wherein the joining connection has a maximum value of a glass pushout force of more than 3900 N.

5. The joining connection of claim 4, wherein the glass pushout force is more than 1300 N per mm of vitrification length.

6. The joining connection of claim 1, wherein the glass comprises at least one glass-forming metal oxide or semimetal oxide of the general formula RO₂ or R₂O₃ and at least one metal oxide of the general formula MO, and wherein a molar ratio of a sum total of the at least one metal oxides of the general formula MO that is encompassed by the glass to a sum total of the at least one glass-forming metal oxide or semimetal oxide of the general formula RO₂ or R₂O₃ that are encompassed by the glass is between at least 0.29 and at most 0.59.

7. The joining connection of claim 6, wherein the at least one glass-forming metal oxide and/or semimetal oxide of the general formula RO₂ or R₂O₃ comprises SiO₂, Al₂O₃, B₂O₃, ZrO₂, La₂O₃, P₂O₅, Fe₂O₃, TiO₂, and/or mixtures thereof and the at least one metal oxide of the general formula MO comprises an alkaline earth metal or ZnO.

8. The joining connection of claim 6, wherein the glass further comprises at least one network transformer of the general formula R₂O comprising an alkali metal oxide.

9. The joining connection of claim 8, wherein the sum total of all metal oxides or semimetal oxides of the general formula RO₂ or R₂O₃ that are encompassed by the glass is at least 50 mol %; and/or a sum total of all network transformers of the general formula R₂O that are encompassed by the glass is from at least 9 mol % to at most 20 mol %; and/or the sum total of all metal oxides of the general formula MO that are encompassed by the glass is more than 15 mol %.

10. The joining connection of claim 1, wherein the glass comprises the following components in mol % based on oxide:

| | |
|---|---|
| SiO₂ | 45-67; |
| Al₂O₃ | 0-4.5; |
| B₂O₃ | 0-less than 8; |
| TiO₂ | 0-10; |
| ZrO₂ | 0-5; |
| La₂O₃ | 0-5; |
| Fe₂O₃ | 0-2; |
| Li₂O | 0-4; |
| Na₂O | 2-12; |
| K₂O | 2-12; |
| ZnO | 0-30; |
| MgO | 0-less than 12; |
| CaO | 0-22; |
| SrO | 0-12; |
| BaO | 0-10; and |
| Fluoride | 0-less than 6. |

11. The joining connection of claim 1, having at least one of the following features:
the glass and/or the electrically insulating component has a coefficient of linear thermal expansion in a range from 20° C. to 300° C. of more than 7.5*10-6/K;
the electrically insulating component comprises a filler;
the glass has a hydrolytic stability determined according to ISO 719 (1994-02) of class 3 or better;
the glass has an alkali stability according to ISO 695 (1989-12) of 2 or better;
the glass has a modulus of elasticity of at least 70 GPa;
the glass has a processing temperature of less than 1000° C.; or
the glass has a softening temperature of less than 800° C.

12. The joining connection of claim 1, wherein one of the at least two joining partners is designed as a base comprising at least one passage opening, wherein the base has a height of at most 10 mm and at least 0.5 mm.

13. The joining connection of claim 1, wherein at least one of the at least two joining partners comprises a metal or a high-temperature-stable ceramic compound.

14. A glass, comprising:
at least one glass-forming metal oxide or semimetal oxide of the general formula RO₂ or R₂O₃, where a sum total of all metal oxides or semimetal oxides of the general formula RO₂ or R₂O₃ that are encompassed by the glass is at least 50 mol % to at most 70 mol %, wherein the at least one glass-forming metal oxide or semimetal oxide comprises SiO₂, Al₂O₃, B₂O₃, ZrO₂, La₂O₃, P₂O₅, Fe₂O₃ TiO₂, and/or mixtures thereof; and
at least one metal oxide of the general formula MO, wherein the at least one metal oxide of the general formula MO comprises an alkaline earth metal or ZnO, wherein a molar ratio of a sum total of the at least one metal oxide of the general formula MO encompassed by the glass to a sum total of the at least one glass-forming metal oxide or semimetal oxide of the general formula RO₂ or R₂O₃ encompassed by the glass is between at least 0.29 and at most 0.59.

15. The glass of claim 14, wherein a sum total of all metal oxides of the general formula MO that are encompassed by the glass is more than 15 mol % to at most 35 mol %.

16. The glass of claim 14, further comprising at least one network transformer of the general formula R₂O, wherein a sum total of all network transformers of the general formula R₂O that are encompassed by the glass is from at least 9 mol % to at most 20 mol %, wherein the network transformer of the general formula R₂O comprises an alkali metal oxide.

17. The glass of claim 14, wherein the glass comprises the following components in mol % based on oxide:

| | |
|---|---|
| SiO₂ | 45-67; |
| Al₂O₃ | 0-4.5; |
| B₂O₃ | 0-less than 8; |
| TiO₂ | 0-10; |
| ZrO₂ | 0-5; |
| La₂O₃ | 0-5; |
| Fe₂O₃ | 0-2; |
| Li₂O | 0-4; |
| Na₂O | 2-12; |
| K₂O | 2-12; |
| ZnO; | 0-30; |
| MgO | 0-less than 12; |
| CaO | 0-22; |
| SrO | 0-12; |
| BaO | 0-10; and |
| Fluoride | 0-less than 6. |

18. The glass of claim 14, wherein the glass has at least one of the following features:
the glass is free of PbO, As₂O₃, CdO, and SeO₂;
the glass comprises refining agents solely in the form of impurities with a content of each refining agent of at most 500 ppm, based on weight;
the glass comprises coloring additions only in the form of impurities with a content of each coloring addition being at most 500 ppm, based on weight; or
the glass is free of Bi₂O₃, TeO₂, GeO₂, Ta₂O₅, Nb₂O₅, Ga₂O₃, Y₂O₃, and InO₂.

19. A method of producing a joining connection, comprising:
melting a glass, the glass comprising:
at least one glass-forming metal oxide or semimetal oxide of the general formula RO₂ or R₂O₃, where a sum total of all metal oxides or semimetal oxides of the general formula RO₂ or R₂O₃ that are encompassed by the glass is at least 50 mol % to at most 70 mol %, wherein the at least one glass-forming metal oxide or semimetal oxide comprises SiO₂, Al₂O₃, B₂O₃, ZrO₂, La₂O₃, P₂O₅, Fe₂O₃ TiO₂, and/or mixtures thereof; and
at least one metal oxide of the general formula MO, wherein the at least one metal oxide of the general formula MO comprises an alkaline earth metal or ZnO, wherein a molar ratio of a sum total of the at least one metal oxide of the general formula MO encompassed by the glass to a sum total of the at least one glass-forming metal oxide or semimetal oxide of the general formula RO₂ or R₂O₃ encompassed by the glass is between at least 0.29 and at most 0.59;
producing a preform, producing the preform comprising producing ribbons and/or fits from the glass or comprising the glass, wherein the ribbons and/or frits are ground to powder and processed to give compressible granules that are compressed to produce the preform, or hot forming to obtain a tube comprising the glass or composed of the glass as the preform;
assembling the preform with at least one joining partner; and
transferring the preform and the at least one joining partner to a kiln to perform a thermal treatment, such that the glass adapts and a connection is formed between the glass and the at least one joining partner.
